(19) United States
(12) Patent Application Publication
(10) Pub. No.: US 2018/0093523 A1
(43) Pub. Date: Apr. 5, 2018

(54) PEN PART

(71) Applicant: SAS DE SAINT ESTEVE, Roquefort les Pins (FR)

(72) Inventor: Olivier WILLIAME, Roquefort les Pins (FR)

(21) Appl. No.: 15/560,655

(22) PCT Filed: Mar. 24, 2016
(86) PCT No.: PCT/EP2016/056675

§ 371 Date: Sep. 22, 2017

(30) Foreign Application Priority Data
Mar. 27, 2015 (FR) 1552585

(51) Int. Cl. B43K 5/00; B43K 7/00; B43K 8/00

(52) U.S. Cl. CPC B43K 5/005; B43K 8/003; B43K 7/005

(57) ABSTRACT

A pen part comprising a hollow tube having an external surface and an internal wall of which delimits a cavity. The hollow tube comprises a stone sleeve an external surface of which at least partly forms the external surface of the hollow tube, and a lining element an external surface of which is applied to an internal surface of the sleeve.

### FIELD OF THE INVENTION

The present invention relates to a pen part and may in particular apply to the formation of at least one part of a pen from among a cap and a pen body. It also relates to a method for manufacturing such a pen part.

The term “pen”, short for writing pen, in the present application means an accessory for writing in the broad sense. The invention thus covers in particular ballpoint pens, ink pens, felt pens or graphite pencils.

### TECHNOLOGICAL BACKGROUND

There exists a very wide range of pens available on the market. In particular, the prices and qualities of pens are especially variable. With the most luxury pens, they generally comprise a body on which the writing tip is situated and a cap attached to the body so as to close the pen.

Such pens are in general in the form of a main elongate element that can be assimilated geometrically to a tube, for example made from plastics or metal material. An end piece is normally attached to the distal end of this elongate element so as to cap the body of the pen. At the opposite end, a head is generally attached, a head at the end of which the writing tip projects. This assembly is hollow so as to receive all or part of the writing means and in particular a cartridge connected to the writing tip. In the context of a graphite pencil, the hollow part may serve to store a plurality of leads.

The parts indicated above are assembled and generally the elongate tube and the head are screwed together. A cap may be attached according to circumstances and itself have an internal cavity allowing part of the body of the pen to pass from the writing tip and protecting it.

Despite the very wide diversity of appearances that current pens have, it turns out that they generally always meet the design indicated above. In such a context, it is to difficult to produce novel aesthetic effects in relation to those already known.

Furthermore, the tubular design of the pen bodies and caps generally limits the methods that can be used for manufacture thereof and the materials that can be used.

One object of the present invention is to solve all or some of the drawbacks of the techniques known up to the present time.

### SUMMARY OF THE INVENTION

A first aspect of embodiments of the invention relates to a pen part comprising a hollow tube having an external surface and further having an internal wall which delimits a cavity. Advantageously, it is characterised wherein the hollow tube comprises a stone sleeve an external surface thereof forms at least partially the external surface of the hollow tube, and a lining element an external surface thereof is applied to an internal surface of the sleeve.

Another aspect of the invention is a pen comprising at least one pen part according to the invention.

Another aspect of embodiments of the invention relates to a manufacturing method comprising a step for forming the hollow tube, characterised in that the step of forming the hollow tube comprises, preferably successively:
i. from a block of stone, the creation of a passage passing through said block so as to form the internal surface of the sleeve;
ii. machining of the external surface of the block so as to form the external surface of the sleeve;
iii. application of a lining element to the internal surface.

### BRIEF INTRODUCTION OF THE FIGURES

Other features, aims and advantages of the present invention will emerge from a reading of the following detailed description and with regard to the accompanying drawings given by way of non-limitative examples, and wherein:

FIG. 1 presents a view in longitudinal section of an example of the invention with regard to a pen body.

FIG. 2 illustrates a longitudinal section of a pen cap implementing the invention.

FIG. 3 shows an illustration of an assembly of a pen body and of a cap, and

FIG. 4 is an external perspective view of the visual result that the invention can produce.

### DETAILED DESCRIPTION

Before going into details of embodiments of the invention, in particular to the illustrated references of the figures, various options are introduced below, either individually, or in all combinations thereof:
the lining element covers the entire internal surface of the sleeve;
the lining element is a hollow cylinder;
the lining element is preferably made from metal (aluminium, brass, etc);
the lining element comprises, at at least one of the ends thereof, an assembly zone configured so as to fix an additional member;
the assembly zone preferably comprises a screw thread;
the sleeve is a hollow cylinder with a thickness of less than 3 millimetres, preferably less than 2.5 mm;
the pen part forms a pen cap;
the pen part form a pen body;
the working of the internal surface and/or of the external surface of the block of stone is carried out by pressurised water jet piercing, making it possible to obtain a sleeve;
insertion and fixing of a lining element inside the sleeve;
an operation is carried out for finishing the external surface of the sleeve after application of a lining element to the internal surface;
the operation for finishing the external surface of the stone cylinder comprises a phase of dressing the cylinder by polishing, preferably by successive polishing phases using diamond tools;
the external surface of the cylinder is advantageously thus worked and polished, taking, as the starting point for the thickness calculations, the generally metal lining element.

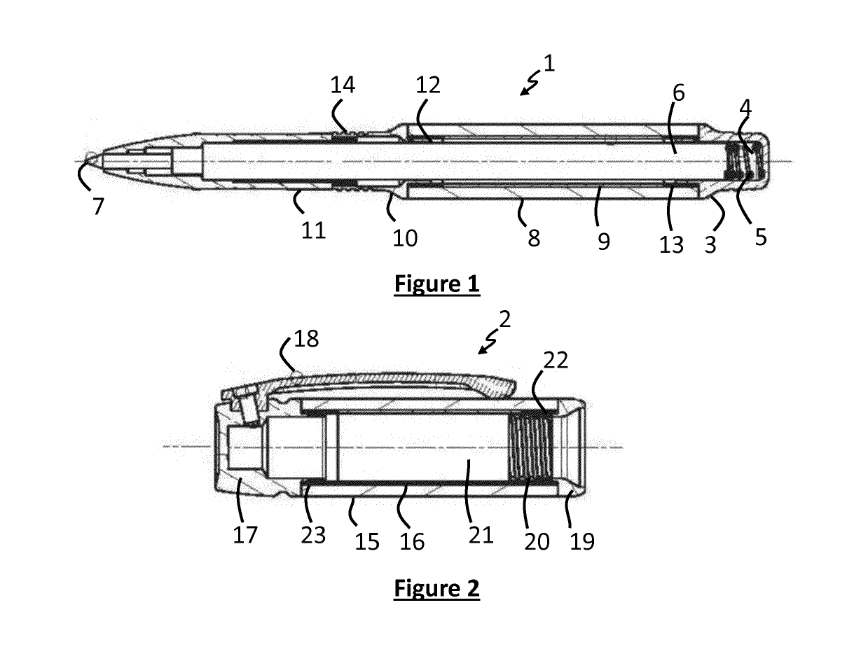

One aspect of the invention relates to a pen part. This pen part may for example take to the form of a cap as illustrated in FIG. 2 under the reference 2 or a pen body such as the one illustrated at reference 1 in FIG. 1.

In an example embodiment, a pen is formed by the combination of such a body 1 and such a cap 2, although this is not limitative.

In the example shown in FIG. 1, the pen body 1 is, conventionally, configured so as to house lighting means that comprise a cartridge 6 disposed in a substantially elongate cavity, for example cylindrical, of the body 1, and a writing tip 7 projecting at the proximal end of the pen body 1.

As indicated previously, the invention does not make any assumption about the writing technology used. The example shown with a tip, of the ballpoint tip type, and a cartridge 6 is therefore purely indicative. According to one aspect of the invention, the internal cavity defined in the body 1 and allowing for example the housing of a cartridge 6, an ink reservoir or leads may be defined at least partly by a hollow tube which, in the illustration, is in the form of a hollow cylindrical portion. According to the invention, at least part of this hollow tube is produced from a mineral material consisting of stone.

The invention does not make any assumption as to the nature of the stone that can be used according to the present invention, but it is obvious that the visual aspects can be varied according to the type of stone used.

Thus the hollow tube of the invention comprises a sleeve 8 produced from stone and, as presented by FIG. 1, extending over a portion of the length of the body 1. Because of the hardness of this type of material, resistance to scratching is particularly high in general. Conversely, this type of material may prove to be fragile in that it is sensitive to breaking. Because of this, in order to ensure the mechanical strength of the body of the pen over time, the present invention proposes to associate therewith a lining element 9, an example which is also shown in cooperation with the sleeve 8 in FIG. 1, here in the form of a hollow cylindrical element, the internal surface of which delimits a part of the internal cavity of the hollow tube of the body 1 of the pen and the external surface of which is configured so as to be applied to the internal wall of the sleeve 8. It will be understood that this cooperation between the internal surface of the sleeve 8 and the external surface of the lining element 9 provides them with cohesion and that thereby the sleeve 8 can benefit from the reinforcement produced by the lining element 9. In this way a composite hollow tube is obtained, formed by at least two parts. Advantageously, the lining element 9 is made from a material different from that of the sleeve 8. Preferably, this material has a lower modulus of elasticity allowing greater elastic deformation of this material than that of the sleeve 8. Preferably, this material is metallic and may be brass.

By way of illustration, it should be noted that the stone sleeve 8 may be a cylinder with circular internal and/or external cross section and the thickness of which is substantially equal to 2 mm. A stone casing can thus be formed that is both strong and sufficiently thin not to excessively increase the weight of the pen. With regard to the lining element 9, it can be produced from a cylindrical element with a circular internal and/or external cross section and/or with a thickness preferably less than 1 mm and advantageously less than 0.5 mm.

The assembly thus formed is, as indicated previously, coherent and interdependent. The lining element 9 can be held in contact with the sleeve 8 by force fitting with a slightly tight fit. Alternatively or additionally, additional fastening means may be provided, for example by means of adhesive bonding.

The hollow tube thus made forms a part that can serve for manual gripping by a user. This part cooperates with other members of the body 1 of the pen. Thus, in the example in FIG. 1, an end piece 3 forms a plug part at one of the ends of the tube formed by the sleeve 8 and the lining element 9, and this end piece 3 comprises in the example an internal blind cavity forming a seat 4 for receiving a spring 5 for holding in elastic abutment the cartridge 6 housed in the body 1 of the pen. By way of example, the end piece 3 may be attached to the tube by contact at the internal surface of the lining element 9. Here, the assembly may be produced for example by adhesive bonding or by screwing, the end piece 3 and the lining element 9 then comprising threaded elements cooperating at this point in the rear assembly zone marked 13 in FIG. 1.

At the other end, the tube cooperates, in the example illustrated, with a coupling 10 that can itself be secured to the tube by means of the lining element 9 at a front assembly zone 12 by means of which the lining element 9 and the coupling 10 cooperate as before by screwing or by adhesive bonding.

In the example, the coupling 10 cooperates itself opposite to its connection with the front assembly zone 12 with as head 11 constituting here a tapered part leading towards the tip of the pen and at which generally the ends of the fingers of the user are applied. In this assembly, a cavity is present so as to enable a writing means to be housed, for example a cartridge 6. At the end of the head 11, an emerging passage enables the writing tip 7 to emerge from the writing means.

The invention may be in various external forms and the example illustrated is therefore purely indicative. However, it is possible for the head 11 to have an elongate cylindrical shape with an outside diameter less than that of the sleeve 8. The coupling 10 may for example make it possible to accommodate this difference in diameter and to have a conical connection portion.

The case thus described presents a pen part in the form of a body 1 incorporating the cooperation of a stone sleeve and a lining element. FIG. 2 gives another application thereof, for another pen part, namely a cap 2.

As before, a sleeve 15 is formed from stone and cooperates with a lining element 16. The descriptive elements given for the example embodiment in FIG. 1 with reference to the sleeve 8 and to the lining element 9 can be repeated for the application to the cap. In particular with regard to the geometric and dimensional choices, the examples given above can be reused, just like the choices of materials.

As in the previous case, the sleeve 15 is preferably entirely lined over its internal wall by the lining element 16 that is applied that is applied thereto.

This time, this portion producing a hollow tube cooperates with two other members at its ends. At a distal end, the tube thus formed is covered by an end piece 17 constituting a top plug at which a clip 18 may be formed conventionally. As before, a rear assembly zone 23 affords connection between the lining element 9 and the cover 17, for example by adhesive bonding or screwing. At the other end of the tube, a bottom finishing part may be produced in the form of a connector 19 that may itself be secured, for example by adhesive bonding or screwing, at a front assembly zone 22 with the lining element 9. The connector part 19 comprises a through hole making it possible to access an internal cavity 21 defined by the tube inside the internal surface of the lining element 16. As before, the composite design of the tube composed by a stone element and a lining element makes it possible to employ materials with a relatively high density (for example stone) with reasonable thicknesses so as to limit the weight of this part.

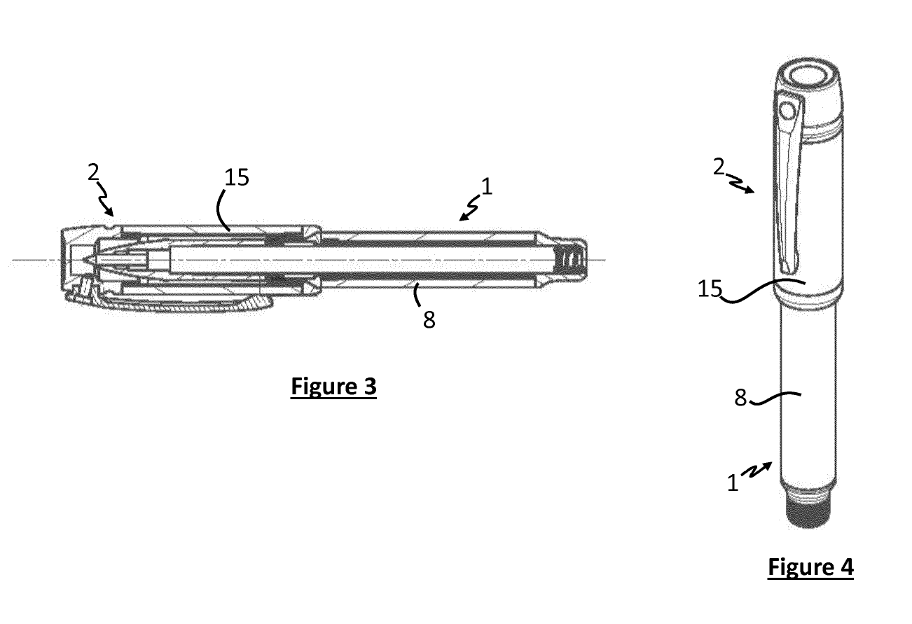

FIG. 3 presents an example of assembly between a first pen part consisting of the body 1 and a second pen part consisting of the cap 2. In this figure, the two parts cooperate so as to close the pen and protect the writing tip 7. This cooperation takes place by means of a thread 14 formed on the body 1 at for example the coupling 10 and cooperating with a female thread 20 produced in the connector 19 of the cap 2. This method of cooperation is not limitative and other types of assembly may be provided, in particular by obstacle without having recourse to screwing.

FIG. 4 discloses the general appearance of the pen thus proposed from the outside with two parts 8, 15 formed from mineral material, stone, so as to offer a pen which is both aesthetically pleasing and scratch resistant. It is understood that the materials used for the parts 8 and 15 are not necessarily the same. Several different stones may also be used to form a sleeve. By way of example, the stones that can be used may comprise lapis-lazuli, sodalite, jaspers, tigereye, etc.

One of the aspects of the invention is the mechanical strength offered by the lining element 9 and the sleeve 8. Furthermore, the lining element 9 may be produced from metal material, which makes it possible to obtain as final surface state of the internal surface of the assembly that is generally of better quality that the surface state that can be obtained for stone worked with reasonable cost and risk of breakage. Thus the internal cavity delimited by the tube formed by the association of the lining element 9 and the sleeve 8 is superior to what would be obtained with a sleeve made from stone alone.

In this following context an example is given of a manufacturing method that can be used for producing such a part. An important step in the manufacture of the pen part is the production of the tube formed by the sleeve 8 and the lining element 9. To achieve this, one possibility consists of starting from a block of stone and producing therein a central through hole, for example with a hollow cylindrical shape. This passage may preferably be produced using a working technique at high pressure (generally at least 4000 bar) wherein a water jet and abrasive elements are applied to the block to be worked so as to produce accelerated erosion of the latter, affording piercing of the stone block. It is thus possible to produce an internal passage constituting the final internal surface of the sleeve 8. Preferably also working of the external surface of the stone block is carried out so as to form a—non-finished—external surface of the sleeve 8, preferably by water jet and abrasive elements also. Once at least the piercing of the internal surface of the sleeve 8 has been carried out, the lining element 9 is applied to said internal surface. The lining element 9 is for example a hollow metal tube, for example made from brass, advantageously made to measure. This assembly may take place with adhesive bonding or be simply carried out by force fitting, the relative dimensions of the passage in the stone block and the cylinder of the lining element being configured so as to allow a slightly tight fit in this case.

At this step, a block of stone is obtained having a central passage. It is then possible to proceed with the final formation of the external surface of the sleeve 8 up until then only smoothed by a finishing working of the outside of the stone block. We thus obtain a hollow mineral cylinder reinforced by a metal lining element 9.

The external finishing working of the sleeve (precise diameter and polishing) is preferably produced by means of the use of diamond tools that will be directly applied to the rotating sleeve, the rotation axis being provided by the lining element 9.

During at least some of these steps applied to the outside of the stone block, it is advantageous to use the lining element 9 as a reference element in the finishing machine. This is because, by virtue of the lining element 9, the invention has a stable reference element, the geometric tolerances and the surface state of which are high in order to allow cooperation, for example, with a fixing device of a finishing machine comprising a centring member around which the lining element 9 can be fixed. The external finishing is therefore indeed carried out in correspondence with the internal surface of the lining element.

At the end of these steps, a hollow tube is obtained wherein the sleeve 8 and the lining element 9 cooperate, with a surface state suitable both through the inside and the outside of the tube. Subsequent manufacturing phases may comprise the cuts at a right angle of the two ends of the mineral sleeves in order to coincide with the dimensions of the lining element 9.

The presence of screwing elements on the ends of the lining element 9 make it possible to cooperate with other members of the pen part in question, such as those indicated previously with reference to the covering pieces 17, connector 19, end piece 3 and coupling 10.

It should be noted that the potential final result is a tube formed from a stone sleeve 8 with a thickness of around 2 mm, and a length for example greater than 4 cm, which combats a consistent prejudice in the prior art according to which this type of working appears to be impossible using material such as stone.

### REFERENCES

1. Pen body
2. Cap
3. Body end piece
4. Seat
5. Spring
6. Cartridge
7. Writing tip
8. Sleeve
9. Lining element
10. Coupling
11. Head
12. Front assembly zone
13. Rear assembly zone
14. Thread
15. Sleeve
16. Lining element
17. Cap end piece
18. Clip
19. Connector
20. Female thread
21. Cavity
22. Front assembly zone
23. Rear assembly zone

1. A pen part comprising a hollow tube having an external surface and further having an internal wall which delimits a cavity, wherein the hollow tube comprises a stone sleeve an external surface thereof forms at least the external surface of the hollow tube, and a lining element an external surface thereof is applied to an internal surface of the sleeve, and where the lining element covers entirely the internal surface of the sleeve.

2. The pen part according to claim 1, wherein the lining element is a hollow cylinder.

3. The pen part according to claim 2, wherein the cylindrical element has a circular cross section and/or a circular external section.

4. The pen part according to claim 2, wherein the cylindrical element has a cross section with a thickness of less than 1 mm.

5. The pen part according to claim 1, wherein the lining element is made from metal.

6. The pen part according to claim 1, wherein the lining element comprises, at at least one of its ends, an assembly zone configured so as to fix an additional member.

7. The pen part according to claim 6, wherein the assembly zone comprises a screw thread.

8. The pen part according to claim 1, wherein the sleeve is a hollow cylinder with a thickness of less than 2.5 millimetres.

9. The pen part according to claim 1, forming a pen cap.

10. The pen part according to claim 1, forming a pen body.

11. A pen comprising at least one part according to claim 1.

12. A method for manufacturing a pen part according to claim 1, comprising a step of forming a hollow tube, wherein the step of forming the hollow tube comprises:
i. from a block of stone, the creation of a passage passing through said block so as to form an internal surface of the sleeve;
ii. machining of an external surface of the block so as to form an external surface of the sleeve; and
iii. application of a lining element to the internal surface.

13. The method according to claim 12, wherein a finishing operation of machining is performed on the external surface of the sleeve after application of the lining element to the internal surface.

14. The method according to claim 13, wherein, during the finishing operation, the sleeve is fixed in position by mounting the lining element around a fixing device.

15. The method according to claim 13, wherein the finishing operation comprises a phase of cutting the cylinder by polishing.

16. The method according to claim 12, wherein the creation of the passage and/or the machining of the external surface is carried out by piercing with a pressurised water jet.

17. The pen part according to claim 3, wherein the cylindrical element has a cross section with a thickness of less than 1 mm.

18. The method according to claim 16, wherein the polishing comprises successive polishing phases by the use of diamond tools.

19. The method according to claim 15, wherein the finishing operation on the external surface of the stone cylinder comprises a phase of cutting the cylinder by polishing.

20. The method according to claim 18, wherein the polishing comprises successive polishing phases by the use of diamond tools.
